(19) United States
(12) Patent Application Publication
(10) Pub. No.: US 2002/0093730 A1
(43) Pub. Date: Jul. 18, 2002

(54) Optical mode expander

(75) Inventors: Craig Tombling, Oxford (GB); Alistair Henderson Kean, Oxford (GB); Martin David Dawson, Glasgow (GB); Anthony Edward Kelly, Glasgow (GB)

Correspondence Address: LAHIVE & COCKFIELD, 28 STATE STREET, BOSTON, MA, 02109, US

(73) Assignee: Kamelian Limited, Oxford (GB)

(21) Appl. No.: 10/044,377

(22) Filed: Jan. 11, 2002

(30) Foreign Application Priority Data
Jan. 13, 2001 (GB) 0100975.2

(51) Int. Cl. H01S 3/00

(52) U.S. Cl. 359/344

(57) ABSTRACT

A semiconductor optical amplifier comprising an active gain region of the (In, Ga)(As, N) system is proposed, together with the use of (Ga, In)(As, N) as the base material for the fabrication of an SOA, and a semiconductor optical amplifier comprising (Ga, In)(As, N) as the base material. The N content of the (In, Ga)(As, N) can be varied along a dimension of the active region in the direction of propagation of light signals therein, to create a varying bandgap such as for mode expanders. The active region can be supplied by a source of electrical bias which is applied in segments along the dimension of the active region, the segments being capable of independent variation. This should allow channel equalisation of WDM signals to be performed dynamically. This scheme could also be used to equalise device parameters such as differential gain, saturation output power and linewidth enhancement factor across the amplification bandwidth.

### FIELD OF THE INVENTION

The present invention relates to semiconductor optical mode expanders. In particular, it proposes the use of the GaInNAs material system in this context. The invention flows from the discovery that the use of this material system should allow a number of novel devices to be fabricated which would not be feasible using the previous materials systems such as InP.

### BAKGROUND ART

Mode expanders are used in optical devices where it is desired to expand the mode of light propagating along the length of an optoelectronic device. These expanders are applicable to optical fibres in particular where the mode of an optoelectronic device may be expanded to facilitate alignment of the two components. Mode expansion is particularly applicable to semiconductor optical amplifiers (SOAs). Presently mode expansion is achieved by introducing a parallel, wider waveguide, beneath the narrow waveguide which is tapered such that the optical mode is forced into the underlying waveguide thus increasing the size of the optical mode (FIG. 1).

Semiconductor optical amplifiers are optoelectronic devices, which use gain in a device to amplify the intensity of an optical signal. The wavelengths of light which are presently of interest are between 1200 and 1600 nm. This is because the transmission through optical fibres is maximised at specific wavelength ranges, which lie between 1.2 and 1.6 μm. The SOAs are fabricated from the groups III and V elements from the periodic table. In order to amplify light between 1.2 and 1.6 μm the group III and V elements which are typically used are gallium (Ga) and indium (In), (both group III), and arsenic (As) and phosphorus (P), (both group V). These materials are doped with impurities from other columns of the periodic table to allow electrical activity, which in turn generates light via the recombination of an electron from a conducting state to an insulating state.

The devices are above are referred to as being of the (Ga, In)(As, P) material group. SOAs fabricated from this material system have been demonstrated. Another material system, recently investigated is (Ga, In)(As, N) on GaAs. There is a minimal amount of strain introduced by the addition of nitrogen, however the advantage of this system is that a relatively small amount of nitrogen is added (<6%) to produce a comparatively large change in bandgap. The refractive index of GaAs based active layers is around 3.37. This means that the waveguiding properties of GaAsN embedded in InP will be different from (In, Ga)(As, P) embedded in InP.

To date, SOA technology is mature in the InP material system at a wavelength of 1.55 μm. Indeed research into SOAs has been performed worldwide since the 1980s. InP based devices, however, have a number of limitations.

InP (the substrate and waveguide buffer material) has a refractive index of 3.16 at 1.55 mm. The active material in this system, typically (In, Ga)(As, P), has an index of 3.58 at the same wavelength. This results in very tightly confined optical modes in (In, Ga)(As, P) waveguided devices. In the case of (Ga, In)(As, N) the substrate and waveguide material is GaAs based and has a refractive index around 3.37. The active material will have an index (as in (In, Ga)(As, P)) of 3.58. Therefore the optical mode in (Ga, In)(As, N) based devices will be much less tightly confined.

### SUMMARY OF THE INVENTION

The present invention proposes to achieve mode expansion by spatially changing the properties of a (Ga, In)(N, As) propagation medium along the length of the device such that the optical mode is expanded by the changing refractive index.

The present invention therefore provides an integrated optical device incorporating at least one waveguide, the waveguide having a mode expander at an end part thereof, the mode expander comprising a local variation in refractive index.

It is preferred that the refractive index variation is achieved by a variation in the band gap. This can be achieved in the (Ga, In)(N, As) system by a variation in the N content, such as by doping. Other methods of controlling the refractive index are known, however, although the N content in the (Ga, In)(N, As) system exerts a powerful effect and is therefore particularly suitable.

The waveguide will usually end at a facet of the device, but this is not essential as particular fixing methods for optical fibres (for example) may require fixing at a point spaced from the facet.

Thus, the present invention permits the characteristics of the (In, Ga)(As, N) system to be harnessed in the following ways to create novel devices.

One of the most important characteristics of any active device is its suitability for packaging since most of the cost in manufacture is incurred during this process. Due to the tightly guided modes in InP devices and the dilute mode of the optical fibre or passive waveguides, the devices have to be actively packaged to very tight alignment tolerances, typically using lenses. One way round this is to use mode expanders at the facet of the device where the optical mode is expanded to the size required. This then allows passive alignment of the devices to optical fibre or waveguides. Usually these mode expanders are formed by introducing a lateral taper to the active region or varying the bandgap as the facet of the device is approached (using complicated regrowth techniques). The use of the (In, Ga)(As, N) system as described herein allows greater flexibility in the design of these mode expanders by making it possible to change the bandgap of the active material. Furthermore, the background index of 3.37 (as opposed to 3.16) means that the optical waveguide is much more dilute before expansion. This allows shorter tapers of lower loss to be designed.

Preferably the effect of the presence of nitrogen can be modified along a dimension of the device in the direction of propagation of light signals therein. The modification may take the form of a continuous, or a stepped variation of the effect.

As previously mentioned the optical mode in (In, Ga)(As, N) based devices will be much more dilute. This means that for any given modal optical power the local intensity will be lower than in InP. This should result in SOA devices with higher output powers.

### BRIEF DESCRIPTION OF THE DRAWINGS

An embodiment of the invention will now be described with reference to the accompanying figures, in which;

FIG. 1 shows a vertical section through a traditional mode expander;

FIG. 2 shows a plan view of the mode expander of FIG. 1;

FIGS. 3 and 4 show variation in refractive index with nitrogen content; and

FIGS. 5 and 6 show a mode expander using a processed (Ga,In)(N,As) waveguide.

### DETAILED DESCRIPTION OF THE EMBODIMENT

One of the most important characteristics of any active device is it's suitability for packaging since most of the cost in manufacture is incurred during this process. Due to the tightly guided modes in (In, Ga)(As, P) devices and the dilute mode of the optical fibre or passive waveguides, the devices have to be actively packaged to very tight alignment tolerances, typically using lenses. One way around this is to use mode expanders at the facet of the device where the optical mode is expanded to the size required. This then allows passive alignment of the devices to optical fibre or waveguides. Usually these mode expanders are formed by introducing a taper to the active region to direct the optical mode towards an underlying passive waveguide.

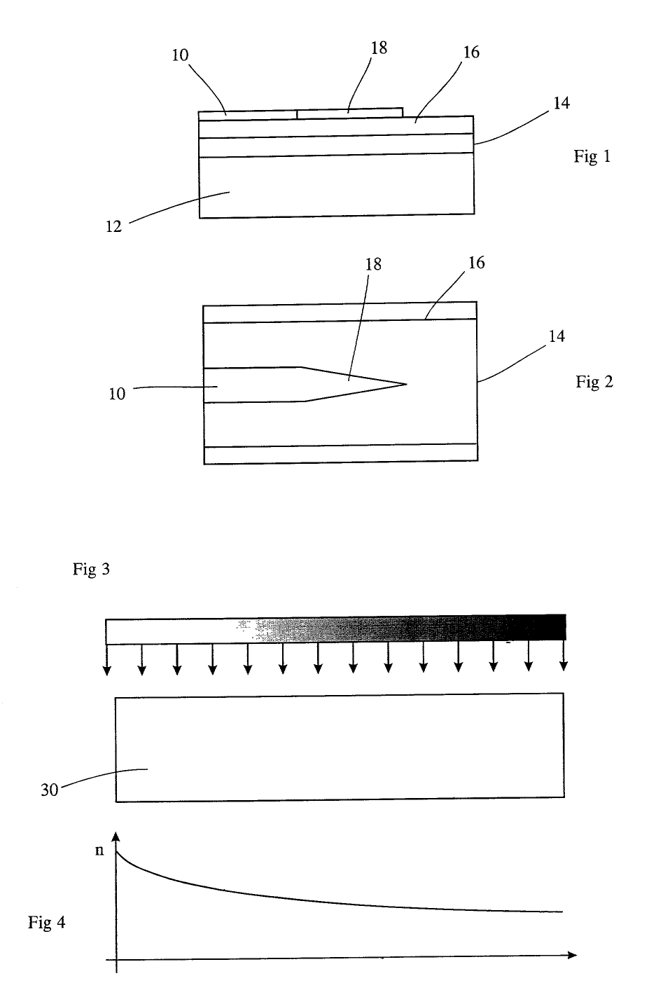

FIG. 1 shows a typical mode expander. A main waveguide 10 defined on the epi layer 12 approaches the facet 14. A wider waveguide 16 is defined beneath the main waveguide 10. Near the facet 14, the main waveguide narrows to a taper 18, forcing an optical mode that it contains into the wider waveguide 16. In this wider waveguide 16, the mode will widen correspondingly as it is carried to the facet 14.

According to the invention, the bandgap is varied towards the facet of the device. The use of (Ga, In)(As, N) allows greater flexibility in the design of these mode expanders by making it possible to change the bandgap of the active material, as shown in FIGS. 3 and 4. These show a device 30 comprising an active region of (In, Ga)(As, N) and cladding layers. The N content is varied as shown by the intensity of shading in FIG. 3, which creates a locally wider bandgap compared to the bandgap elsewhere in the device, as shown by the refractive index variation (FIG. 4). This can be employed to allow the optical mode to expand immediately prior to reaching the facet, allowing better coupling to an optical fibre.

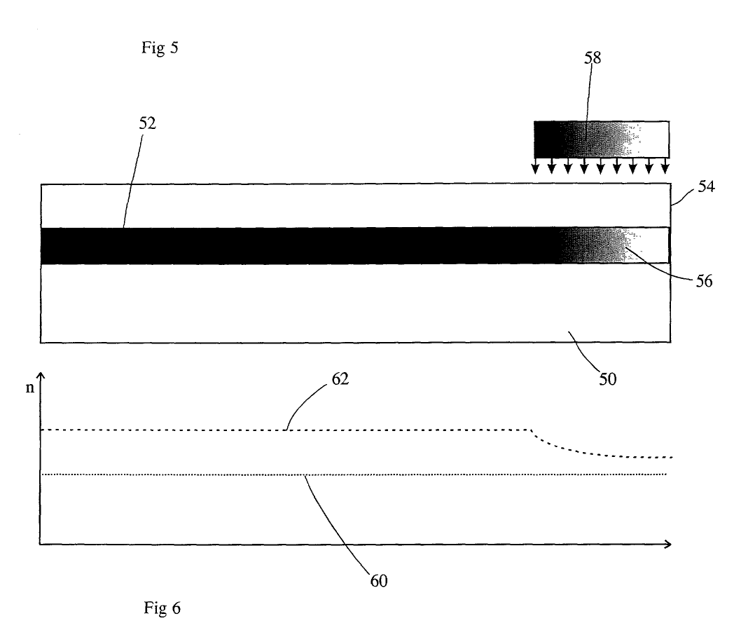

This is shown in FIGS. 5 and 6, where the device 50 has an active region 52 in which the N content is steady until close to the facet 54 of the device. In the area 56 near the facet, the N content varies smoothly as shown by shading 58.

This results in the refractive index profile shown in FIG. 6. The steady line 60 is the refractive index of the cladding whereas line 62 is the refractive index of the active region 52. Near the facet 54, the refractive index of the active region drops to a value closer to that of the cladding. This will cause the optical mode to expand locally, as desired.

It will of course be appreciated that many variations may be made to the above-described embodiments. In particular, the described embodiments are schematic in nature and will typically be incorporated as part(s) of a larger device. Although a smooth and steady variation in refractive index is shown, the variation could be stepped or logarithmic etc to similar effect.

1. An integrated optical device incorporating at least one waveguide, the waveguide having a mode expander at an end part thereof, the mode expander comprising a local variation in refractive index.

2. A device according to claim 1 in which the refractive index variation is achieved by a variation in the band gap.

3. A device according to claim 2 in which the variation in band gap is achieved by variation in an alloying content.

4. A device according to claim 1 formed in the (Ga, In)(N, As) system.

5. A device according to claim 4 in which refractive index variation is caused by variation in the N content.

6. A device according to claim 1 in which the waveguide ends at a facet.

7. A device according to claim 1 in which the variation in refractive index takes place along a dimension of the device in the direction of propagation of light signals therein.

8. A device according to claim 1 in which the variation is continuous.

9. A device according to claim 1 in which the variation is stepped.
